(19) United States
(12) Patent Application Publication
(10) Pub. No.: US 2009/0016063 A1
(43) Pub. Date: Jan. 15, 2009

(54) Built-in Heat Diffusion Lamp Body for LED Lamp

(76) Inventor: KAI HU, Schenzhen (CN)

Correspondence Address: BUTLER, SNOW, O'MARA, STEVENS & CANNADA PLLC, 6075 POPLAR AVENUE, SUITE 500, MEMPHIS, TN, 38119, US

(21) Appl. No.: 11/872,818

(22) Filed: Oct. 16, 2007

(30) Foreign Application Priority Data
Jul. 15, 2007 (CN) 200720121681.2

(51) Int. Cl. F21V 9/00; F21V 29/00

(52) U.S. Cl. 362/294; 362/373

(57) ABSTRACT

A built in beat diffusion lamp body for LED lamp was invented. The purpose of the invention is to solve the difficulties of poor heat conduction and diffusion caused by the small heat diffusion surface of the material of a conventional LED lamp. The lamp body is made of a set of heat diffusion vanes encircling the heat diffusion complex. The vanes and heat diffusion complex are made from Aluminum alloy in a single process of extrusion moulding. The transverse section of the heat diffusion body is volute shaped. The bottom of the heat diffusion complex is fixed to an aluminum board or an aluminum circuit: board by interference fit. The heat generated by the LED elements can be absorbed and diffused by the board, the heat diffusion complex and the surrounding diffusion element. The outward appearance of the heat diffusion lamp body may be shaped into cup, ladder, or cylinder likeness to satisfy the application requirement. The advantages of current invention are: efficient heat absorption, conduction, and diffusion, low cost for manufacturing, and aesthetic appearance.

### FIELD OF THE INVENTION

This invention is generally directed to the manufacturing of a new built-in heat diffusion lamp body for LED lamp. It details the structure of the heat diffusion body, material, and provides a suitable manufacturing process.

### DESCRIPTION OF RELATED ART

With the widening use of the LED (“light emitting diode”) lamp, for its environmentally friendliness and energy savings, the need for more efficiency rose tremendously. The insufficient heat diffusion had become the obstacle that has limited the application and development of LED lamp. The poor heat conduction and diffusion of conventional aluminum cast LED lamp has not been viewed as successful in meeting the application needs. Attempts in increasing the heat diffusion area have inevitably enlarged the sizes of the LED lamp, making the design unfavorable in practical circumstances.

### SUMMARY OF THE INVENTION

In order to overcome the technical difficulty in poor heat diffusion of a conventional aluminum cast LED lamp body, the present invention has made improvement in the structure of heat diffusion body, the material used, and the technology in the manufacture.

The present invention seeks to solve the problems of poor heat diffusion, by: optimizing the volume for heat diffusion based on the power cost, available spaces, and the essential factors, such as the working environment. Based upon these parameters, the shape and size of the heat diffusion body was designed. By using the technique of extrusion moulding, the heat diffusion body, including the heat diffusion complex and heat diffusion vanes, can be manufactured at a lower cost. The required volume and outward appearance are met by secondary processing.

The present invention has the advantages of maximizing the heat diffusion area and minimizing the heat diffusion body, optimizing the heat diffusion efficiency, lowering the cost in manufacture, and presenting an elegant appearance. In addition, energy efficiency and efficient heat diffusion will add long life spans for the LED lamp. Experiments with, a 4 or a 7 watt LED lamp showed the present invention decreased the temperature in the central LED lamp by 14 degrees Celsius, prolonged the lifetime of the LED lamp by 30%, and increased the lamp efficiency by 40%.

### BRIEF DESCRIPTION OF THE DRAWINGS

FIG. 1 is a side view of the first embodiment of the built-in heat diffusion lamp body for LED lamp.

FIG. 2 is a side view of the second embodiment of the built-in heat diffusion lamp body for LED lamp.

FIG. 3 is a cross-section view of the first embodiment of the built-in heat diffusion lamp body for LED lamp.

FIG. 4 is a cross-section view of the second embodiment of the built-in heat diffusion lamp body for LED lamp.

### DETAILED DESCRIPTION OF THE PREFERRED EMBODIMENTS

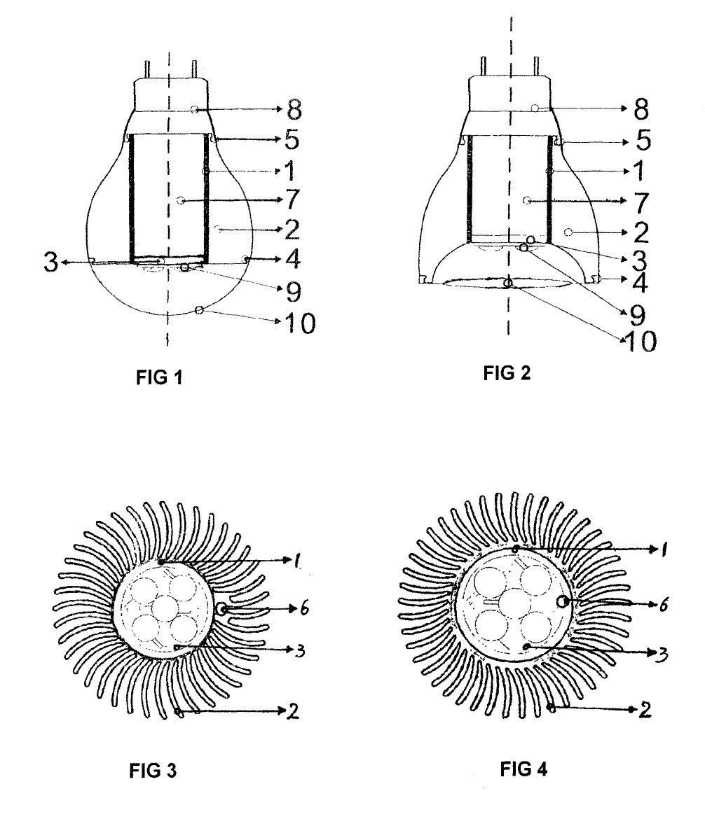

As shown in FIG. 1, the LED lamp assembly includes the heat diffusion complex (1), the diffusion element (2) evenly surrounding the hollow space (7) in the heat diffusion complex (1), the slot (4) for fastening light-gathering cover, slots (5) for fastening power supply (8), and the opening for internal connection wire (6).

The beat diffusion complex (1) and heat diffusion element (2) are manufactured through single process of extrusion moulding from Aluminum alloy. The above described structure, material used, and the technology in mechanical manufacture will re line the product and improve the heat diffusion efficiency of the heat diffusion complex. The heat diffusion lamp body is made of the diffusion element (2) that has a cross sectional shape to facilitate heat transfer. More specifically, the diffusion element (2) has straight or spiral fins or vanes, such as star, turbine or a volute with heat diffusion complex (1) at the center. The necessary volume and final shape of outward appearance are met with secondary processing such as machining. The outward appearance of the heat diffusion lamp body may be shaped into cup, ladder, or cylinder likeness upon request.

There are slots or grooves (4) and (5) in the heat diffusion complex (1) to fasten the light-gathering cover (10) and power supply (8) with the heat diffusion complex (1), respectively. The opening or conduit (6) for internal connection with wire is used to connect LED elements (9) and power supply (8). The slots or grooves (4) and (5) integrate the heat diffusion complex (1), LED power supply (8), and the light-gathering cover (10) together in the final LED lamp assembly.

The aluminum board or circuit board (3), which fixes the bottom end of heat diffusion complex (1), is preferably made from aluminum or other material with good heat conduction properties. Board (3) mounts the LED elements (9). When the LED lamp is turned on, the heat produced by LED elements (9) is absorbed by the aluminum board (3), and the heat is further conducted and diffused by the heat diffusion complex (1) and the encircling heat diffusion element (2).

The internal connection wire opening or conduit (6) on the aluminum board (3) is used to connect the LED elements (9) and power supply (8). The built-in heat diffusion lamp body is further characterized by an opening (6) for connection wire on the aluminum board or an aluminum circuit board (3) that seals one end of the hollow space (7) in the beat diffuse complex (1). The connection wire connects to the LED elements (9) with the power supply (8). The heat diffusion complex (1), LED power supply (8), and light-gathering cover (10) of LED lamp are fastened together at the slots (4,5), comprising the illuminating section of the lamp.

The heat diffusion element (2) that encircles the heat diffusion complex (1) can take star-like cross-sectioned shapes which increase or maximize the heat transfer surface area. The shapes may range from straight radial vanes to spiral turbine or a volute with heat the diffusion complex (1) as the center. The heat diffusion lamp body can be made of aluminum alloy by the single process of extrusion molding.

To facilitate the manufacture of the heat diffusion complex (1), the center of the heat diffusion complex (1) is designed with a hollow space (7). The bottom of the hollow space (7) can be fixed with an aluminum board or electrical circuit board (3); the LED elements (9) are attached to the board (3), and the internal connection wire connects the LED elements (9) and power supply (8). The final heat diffusion LED lamp is assembled by fastening the heat diffusion complex (1) with the power supply (8) by slot or grooves (5), and the light-gathering cover (10) by slot or grooves (4), respectively.

Accordingly, it is expressly intended that the foregoing description and accompany drawings are illustrating in purpose and not intended to limit the scope of the invention.

1. An apparatus configured to hold a LED comprising:
a heat diffusion, element, wherein is said heat diffusion element has a cross-sectional shape to facilitate heat transfer, said heat diffusion element evenly surrounding a hollow chamber having an aluminum base, said aluminum base configured to receive a LED.

2. The apparatus of claim 1 further comprising a LED attached to said aluminum base.

3. The apparatus of claim 2 further comprising at least one opening in said aluminum base to receive a connection wire to seal said hollow chamber said connection wire connects said LED element to a power supply.

4. The apparatus of claim 1 further comprising of slots in said heat diffusion element configured to receive a light gathering cover.

5. The apparatus of claim 4 further comprising a light gathering cover connected to said slot.
